(19) United States
(12) Patent Application Publication
(10) Pub. No.: US 2015/0002953 A1
(43) Pub. Date: Jan. 1, 2015

(54) MIRROR TYPE DISPLAY APPARATUS AND METHOD OF MANUFACTURING THE SAME

(71) Applicant: Samsung Display Co., LTD., Yongin-City (KR)

(72) Inventor: Young-Sik YOON, Seoul (KR)

(73) Assignee: Samsung Display Co., LTD., Yongin-City (KR)

(21) Appl. No.: 14/203,341

(22) Filed: Mar. 10, 2014

(30) Foreign Application Priority Data
Jul. 1, 2013 (KR) 10-2013-0076322

(51) Int. Cl. G02B 5/08

(52) U.S. Cl. CPC G02B 5/08
USPC 359/850; 445/24

(57) ABSTRACT

A mirror type display apparatus comprises a base substrate having a pixel region and a non-pixel region surrounding the pixel region, a driving device, a display device, a protective substrate and an island-shaped reflective layer disposed on a surface of the protective substrate. The island-shaped reflective layer including the island-shaped reflective layers separated by furrows formed on the protective substrate. The island-shaped reflective layer can minimize a warpage caused by a mismatch of coefficient of thermal expansion (CTE) between the protective substrate and the reflective layer.

### CROSS-REFERENCE TO RELATED APPLICATION(S)

This application claims priority under 35 USC §119 to Korean Patent Applications No. 10-2013-0076322, filed on Jul. 1, 2013 in the Korean Intellectual Property Office (KIPO), the contents of which are incorporated herein in its entirety by reference.

### BACKGROUND

1. Technical Field

Exemplary embodiments relate generally to a display apparatus. More particularly, embodiments of the inventive concept relate to a mirror type display apparatus and a method of manufacturing the same.

2. Description of the Related Art

Recently, a flat display apparatus having high definition and slim thickness has been developed, so that many device applications using the flat display apparatus have also been developed. A mirror type display apparatus is one of the device applications. When the mirror type display apparatus is turned off, a screen of the mirror type display apparatus becomes a mirror. When the mirror type display apparatus is turned on, an image is displayed on the screen to display some information. Thus, when the mirror type display apparatus is applied to the practical life, people can preview their looks without trying on various dresses. People can check their physical condition by looking at their face through the mirror type display apparatus combined with some medical equipment. When a side-view mirror or a rear-view mirror of a vehicle includes the mirror type display apparatus, the side-view mirror or the rear-view mirror can help a driver to safely recognize some useful information of a traffic condition or location information.

As mentioned above, the mirror type display apparatus has been widely used in various industrial fields. However, it is difficult to ensure both high reflectivity of the mirror and high luminance of the display. Many advanced technology are now developing to achieve the high reflectivity of the mirror and the high luminance of the display. During the process of forming a reflective layer for the reflectivity, many defects are occurred and, thus, a production yield is decreasing due to a mismatch of thermal expansion coefficients (CTE) between a reflective layer and a protective substrate.

### SUMMARY

Some exemplary embodiments provide a mirror type display apparatus reducing a warpage caused by a mismatch of thermal expansion coefficients (CTE) between a reflective layer and a protective substrate.

Some exemplary embodiments provide a method of manufacturing the mirror type display apparatus having a high luminance as well as an improved reflectivity.

According to some exemplary embodiments, a mirror type display apparatus includes a base substrate, a driving device, a display device, a protective substrate and an island-shaped reflective layer disposed on a side of the protective substrate. The base substrate has a pixel region and a non-pixel region surrounding the pixel region, and the driving device is disposed on the base substrate. The display device is disposed in the pixel region of the base substrate, and the display device is electrically connected to the driving device. The protective substrate opposes the base substrate, and the protective substrate has a function to protect the driving device and the display device from external environment. The reflective layer is disposed on a surface of the protective substrate, and the reflective layer is disposed to have the island shape. The island-shaped reflective layer may include the island-shaped reflective layers separated by furrows formed on the protective substrate

In exemplary embodiments, the island-shaped reflective layer may include a metal. The metal having a high reflectivity for visible light may provide the mirror type display apparatus with a reflectivity.

In exemplary embodiments, the island-shaped reflective layer may further include an opening to expose the pixel region. The opening may provide the mirror type display apparatus with an improved luminance.

In exemplary embodiments, the island-shaped reflective layer may comprise a thick reflective layer and a thin reflective layer thinner than the thick reflective layer, and the thin reflective layer is disposed on the pixel region. The thin reflective layer having higher transmittance for visible light than the thick island-shaped reflective layer may provide improved luminance and reflectivity.

Therefore, the island-shaped reflective layer of the mirror type display apparatus may reduce the warpage caused by the mismatch of CTE between the protective substrate and the reflective layer. In other words, a furrow disposed in a space between the island-shape reflective layers can release a stress caused by the mismatch of CTE between the protective substrate and the reflective layer.

In addition, according to the exemplary embodiments, the mirror type display apparatus may include the opening or the thin reflective layer disposed in the pixel region of the protective substrate, in order to improve the luminance with maintaining the reflectivity.

According to some exemplary embodiments, a method of manufacturing the mirror type display apparatus is provided as follows. A driving device is formed on the base substrate having a pixel region and a non-pixel region surrounding the pixel region. A display device electrically connected to the driving device is formed. The display device is formed on the base substrate. A reflective layer is formed on a surface of a protective substrate. The reflective layer may be island-shaped reflective layers separated by furrows formed on the protective substrate. The protective substrate is bonded to the base substrate to encapsulate the driving device and the display device.

In exemplary embodiments, the forming the reflective layer may further include forming an opening on the pixel region.

The forming an opening and forming the reflective layer may be performed at the same time.

The forming an opening and the forming the reflective layer may be formed by a mask deposition.

In exemplary embodiments, the forming the reflective layer may further include partially removing the reflective layer on the pixel region.

In exemplary embodiments, forming the reflective layer may include forming a photoresist on the reflective layer, exposing the photoresist using a half-tone mask having a transmitting region, a shading region and a half-tone region corresponding to the pixel region, developing the photoresist, etching the reflective layer to form the furrows, removing the photoresist corresponding on the pixel region; and partially removing the reflective layer on the pixel region.

Therefore, according to the method of manufacturing the mirror type display apparatus, the mirror type display apparatus having a minimized warpage is manufactured. In addition, the opening or the thin reflective layer is formed in the reflective layer so that luminance and reflectivity of the mirror type display apparatus may be improved.

### BRIEF DESCRIPTION OF THE DRAWINGS

Illustrative, non-limiting exemplary embodiments will be more clearly understood from the following detailed description taken in conjunction with the accompanying drawings.

FIG. 1 is a cross sectional view illustrating a mirror type display apparatus according to exemplary embodiments of the present invention.

FIG. 2 is an enlarged cross sectional view illustrating a region ‘A’ of the display apparatus of FIG. 1.

FIG. 3 is a plan view illustrating a protective substrate and a reflective layer included in the mirror type display apparatus of FIG. 1.

FIG. 4 is a cross sectional view illustrating a mirror type display apparatus according to another exemplary embodiment of the present invention.

FIG. 5 is a plan view illustrating a protective substrate and a reflective layer of the mirror type display apparatus of FIG. 4.

FIGS. 6A to 6C are cross sectional views illustrating a method of manufacturing a mirror type display apparatus according to the exemplary embodiments of the present invention.

FIGS. 7A to 7C are plan views illustrating a method of forming a reflective layer of a mirror type display apparatus according to exemplary embodiments of the present invention.

FIGS. 8A to 8C are cross sectional views illustrating a method of forming a reflective layer of a mirror type display apparatus according to exemplary embodiments of the present invention.

FIGS. 9A to 9C are cross sectional views illustrating a method of forming a reflective layer of a mirror type display apparatus according to exemplary embodiment of the present invention.

### DETAILED DESCRIPTION OF THE EMBODIMENTS

Various exemplary embodiments will be described more fully hereinafter with reference to the accompanying drawings, in which some exemplary embodiments are shown. The present inventive concept may, however, be embodied in many different forms and should not be construed as limited to the exemplary embodiments set forth herein. Rather, these exemplary embodiments are provided so that this disclosure will be thorough and complete, and will fully convey the scope of the present inventive concept to those skilled in the art. In the drawings, the sizes and relative sizes of layers and regions may be exaggerated for clarity. Like numerals refer to like elements throughout.

It will be understood that, although the terms first, second, third etc. may be used herein to describe various elements, these elements should not be limited by these terms. These terms are used to distinguish one element from another. Thus, a first element discussed below could be termed a second element without departing from the teachings of the present inventive concept. As used herein, the term “and/or” includes any and all combinations of one or more of the associated listed items.

It will be understood that when an element is referred to as being “connected” or “coupled” to another element, it can be directly connected or coupled to the other element or it can be connected or couples to the other element with intervening elements therebetween. In contrast, when an element is referred to as being “directly connected” or “directly coupled” to another element, there are no intervening elements between the elements. Other words used to describe the relationship between elements should be interpreted in a like fashion (e.g., “between” versus “directly between,” “adjacent” versus “directly adjacent,” etc.).

The terminology used herein is for the purpose of describing particular exemplary embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

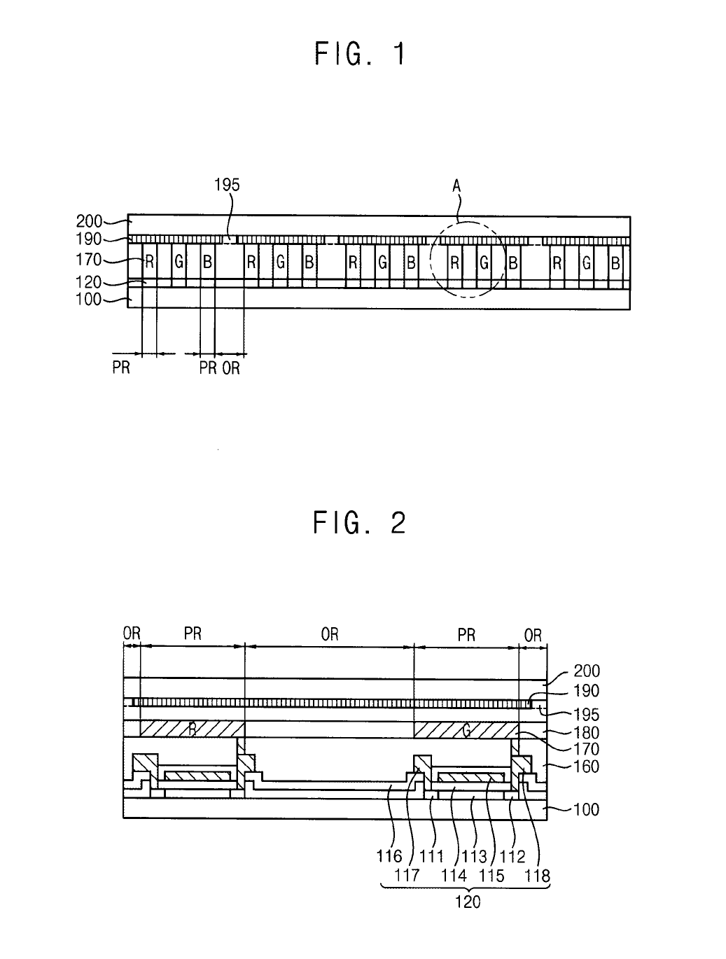

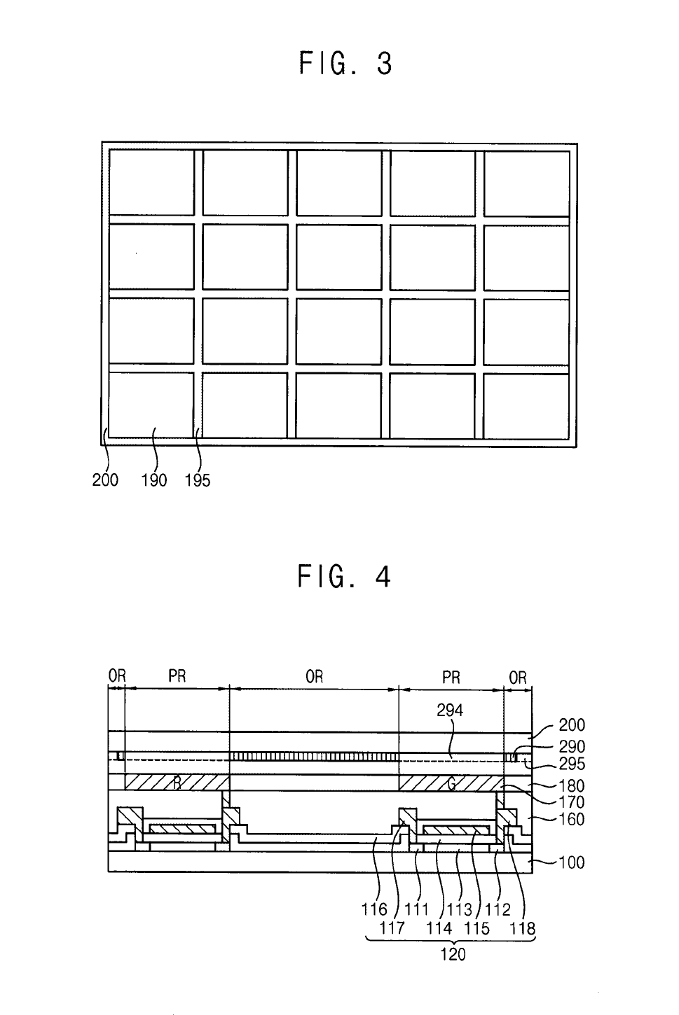

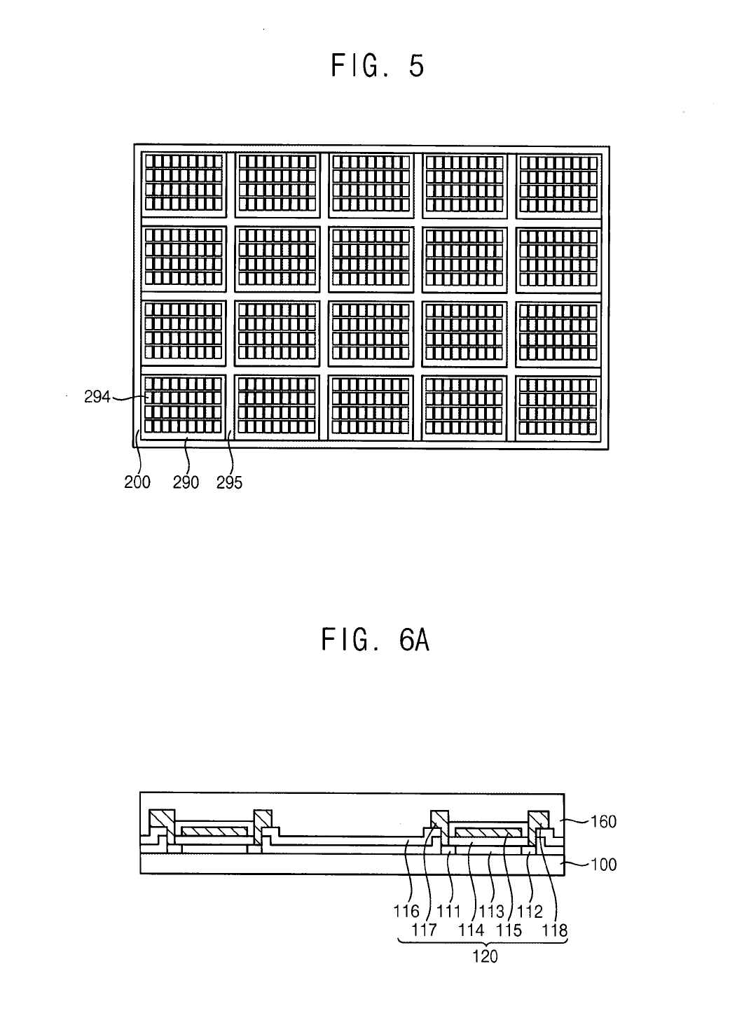

FIG. 1 is a cross sectional view illustrating a mirror type display apparatus according to exemplary embodiments of the present invention. FIG. 2 is an enlarged cross sectional view illustrating a region ‘A’ of the display apparatus of FIG. 1. FIG. 3 is a plan view illustrating a protective substrate and a reflective layer included in the mirror type display apparatus of FIG. 1.

Referring to FIG. 1, the mirror type display apparatus according to an exemplary embodiment of the present invention includes a base substrate 100, a driving device 120, a display device 170, a reflective layer 190 and a protective substrate 200. Each element of the mirror type display apparatus will be described hereinafter.

For exemplary, the mirror type display apparatus may be a flat display apparatus such as an organic light emitting display apparatus, a liquid crystal display apparatus, a plasma display panel, a filed emission display apparatus, an electrophoretic display apparatus, etc.

The base substrate 100 may be an inorganic substrate including a glass or poly silicon, and may be a plastic substrate including a polyethylene terephthalate (PET), a polyethylen naphthalate (PEN), a polyimide, etc. The base substrate 100 may be a flexible display substrate including a metal or a polymer having flexibility. The base substrate 100 consists of a pixel region which includes display device 170 and a non-pixel region OR which surround the pixel region PR.

The driving device 120 is disposed on the base substrate 100, and the driving device 120 is electrically connected to the display device 170. In the exemplary embodiment, the driving device 120 may include switch device such as thin film transistor (TFT). In another exemplary embodiment, the driving device 120 may further include other devices besides TFT. For example, the driving device 120 may include TFT and a capacitor in order to drive the display device 170 more stably. A cross sectional view of the driving device 120 is shown in FIG. 2. The FIG. 2 is enlarged cross sectional view illustrating a region ‘A’ of the display apparatus of FIG. 1.

Referring to FIG. 2, the driving device 120 includes TFT, the TFT includes a semiconductor layer 111, 112 and 113, a gate insulation layer 114, a gate electrode 115, an insulating interlayer 116, a source electrode 117 and drain electrode 118.

In the exemplary embodiment, the semiconductor layer 111, 112 and 113 is disposed on the base substrate 100, and the semiconductor layer 111, 112 and 113 may include a poly silicon, a poly silicon having an impurity, an amorphous silicon, an amorphous silicon having an impurity, an oxide semiconductor, an oxide semiconductor including impurity, etc, which are used alone or in combination. The semiconductor layer 111, 112 and 113 includes two impurity regions 111 and 112 having an impurity, and the two impurity regions are separated each other. For example, the impurity regions 111 and 112 may include atoms having a valency of 5 such as antimony (Sb), arsenic (As), phosphorus (P), etc. In this example, the TFT is N type TFT. The impurity regions 111 and 112 may include atoms having a valency of 3 such as boron (B), gallium (Ga), indium (In), etc. In this example, the TFT is P type TFT.

The gate insulation layer 114 may include an oxide or an organic insulating material. For example, the gate insulation layer 114 may include a silicon oxide, an aluminum oxide (AlOx), a titanium oxide (TiOx), an acryl-based resin, etc. The gate insulation layer 114 may have a single-layered structure or a multi-layered structure including the oxide or the organic insulating material.

The gate electrode 115 is disposed on the gate insulation layer 114 adjacent to the semiconductor layer 111, 112 and 113. The gate electrode 115 may include a metal, a metal nitride, a conductive metal oxide, a transparent conductive material, etc.

The insulating interlayer 116 covering the gate electrode 115 may be disposed on the gate insulation layer 114. The insulating interlayer 116 may include an oxide, a nitride, an oxynitride, and an organic insulating material which are used alone or in combination. The insulating interlayer 116 may sufficiently cover the gate insulation layer 114 and have sufficiently flat surface.

The source electrode 117 and the drain electrode 118 is electrically connected to the impurity regions 111 and 112 of the semiconductor layer through a contact hole formed in the insulating interlayer 116 and the gate insulation layer 114. The source electrode 117 and the drain electrode 118 may include a metal, a metal nitride, a conductive metal oxide, a transparent conductive material, etc which are used alone or in combination.

In the exemplary embodiment, an insulation layer 160 may be disposed on the insulating interlayer 116 in order to cover the source electrode 117 and the drain electrode 118. For example, the insulation layer 160 may include a benzocyclobutene-based resin, a polyimide-based resin, an arcyl-based resin, etc which are used alone or in combination.

The display device 170 may be disposed on the insulation layer 160, and is electrically connected to driving device 120 through a contact hole formed in the insulation layer 160. A various devices may be used as the display device 170. In the exemplary embodiment, the display device 170 may include an organic light emitting diode. A pixel may include three organic light emitting diodes emitting red, green and blue light. The organic light emitting diode includes a pixel electrode electrically connected to the driving device 120 through a contact hole formed in the insulating layer 160, an opposite electrode opposite to the pixel electrode, an organic layer disposed between the pixel electrode and the opposite electrode. The organic light emitting diode can display image by light emitted from the organic layer caused by applied voltage between the pixel electrode and the opposite electrode. In another exemplary embodiment, the display device 170 may include a liquid crystal device. The liquid crystal device consists of a pixel electrode, a liquid crystal, a common electrode, a color filter, a back light unit, etc. The liquid crystal device can display image by changing arrangement of the liquid crystal caused by applied voltage between the pixel electrode and the common electrode. In still another exemplary embodiment, the display device 170 may be a display device of the plasma display panel (PDP). The display device of PDP includes an address electrode, a phosphor layer, a dielectric layer, a scan electrode, a sustain electrode, etc. The display device of PDP can display image by following procedure that applying a voltage to the address electrode electrically connected to the driving device 120, generating an energy by discharging ions of inert gas in the phosphor layer and emitting a light of phosphor layer by the generated energy.

The protective substrate 200 is disposed on the display device 170, and protects the display device 170 and driving device 120 from external environment. The protective substrate 200 should have chemical stability in order to protect the display device from external moisture and gas, and the protective substrate 200 should have excellent visible light transmittance in order to transmit the light visible that is emitted by the display device 170 well. Thus, the protective substrate 200 may include a glass, a transparent metal film, an insulation layer consisting of an organic material or an inorganic material, etc. In another exemplary embodiment, the protective substrate 200 may further include some film including titanium dioxide (TiO₂) for example, in order to prevent a wavering of the image.

The reflective layer 190 is disposed on a surface of the protective substrate 200. In an exemplary embodiment, the reflective layer 190 may be disposed on the lower surface of the protective substrate 200, as illustrated in FIGS. 1 and 2. In this embodiment, the protective substrate 200 may have a flat upper surface. In another exemplary embodiment, the reflective layer 190 may be disposed on the upper surface of the protective substrate 200. In this embodiment, the protective substrate 200 may have a flat lower surface. The reflective layer 190 has a good reflectivity in order to have a function as a mirror. Specifically, the reflective layer 190 may reflect visible light. The reflective layer 190 may include a metal reflecting the visible light. For example, the reflective layer 190 may include aluminum (Al), silver (Ag), titanium (Ti), chrome (Cr), etc which reflect visible light as well as transmit visible light according to its thickness. In this example, a thickness of the reflective layer 190 may be adjusted in order to have reflectivity of 50% to 90%. In the exemplary embodiment, the reflective layer 190 may include the metal only. In another exemplary embodiment, the reflective layer 190 may include a reflective polarizing film such as dual brightness enhancement film (DBEF) to further increase the luminance of the mirror type display apparatus. In the exemplary embodiment, the reflective layer 190 may be disposed on the protective substrate 200 not to cover entire surface of the protective substrate 200. For example, the reflective layer 190 may be disposed on the protective substrate 200 as island-shaped pattern. Thus, the island-shaped reflective layer 190 can reduce a warpage of protective substrate 200 caused by a mismatch of thermal expansion coefficients (CTE) between the reflective layer 190 and the protective substrate 200 during heating process. When the reflective layer covers the entire surface of the protective substrate, the protective substrate warps during heating process due to the mismatch of the CTE between the protective substrate and the reflective layer. The warpage prevent the protective substrate from tightly encapsulating the display device. However, the island-shaped reflective layer 190 according to the exemplary embodiments of the present invention includes furrows 195 disposed in a space between the island-shaped reflective layers 190, as illustrated in FIG. 1. For example, the furrows 195 may be disposed to have lattice pattern having a horizontal line and a vertical line, as illustrated in FIG. 3. The furrows 195 release a stress of the protective substrate 200 and, thus, prevent the protective substrate 200 from warping. The furrows 195 may be formed in the non-pixel region OR on the protective substrate 200. In other words, the furrow 195 may be formed in any region except for the pixel region PR in which the display device 170 is disposed. When the furrow 195 is disposed on the pixel region PR, a light emitted by the display device 170 may be reflected or dispersed by the furrow 195. So that, the furrow 195 may be formed in the non-pixel region OR on the protective substrate 200. For example, the furrow 195 may be formed along an outline of a group of pixels that is formed by predetermined a plurality of display devices 170, to surround the pixels. However, an arrangement of the furrows 195 is not limited by the example above. The furrows 195 may be disposed as a various patterns.

In an exemplary embodiment, the protective substrate 200 including the reflective layer 190 may be disposed to be apart from the display device 170 by a predetermined distance, as illustrated in FIG. 2. For example, a spacer to separate the display device 170 from the protective substrate 200 is disposed on the base substrate 100. The protective substrate 200 may be apart from the display device 170 by the spacer. The spacer may include any material having chemical and physical stability and having high strength against external impact. In another exemplary embodiment, the protective substrate 200 including the reflective layer 190 may be disposed directly on the display device 170. For example, the reflective layer 190 may be disposed on an upper surface of the protective substrate 200, and the protective substrate 200 may directly contact the display device 170. In this example, the luminance of the mirror type display apparatus can be improved, because an image is directly displayed through the protective substrate 200 from the display device 170. In still another exemplary embodiment, another layer may further be disposed between the reflective layer 190 and the display device 170. For example, an insulation layer may be disposed between the reflective layer 190 and the display device 170 to prevent electrical connection between the reflective layer 190 and the display device 170. The insulation layer may have transparency in order to maintain the luminance of the mirror type display apparatus.

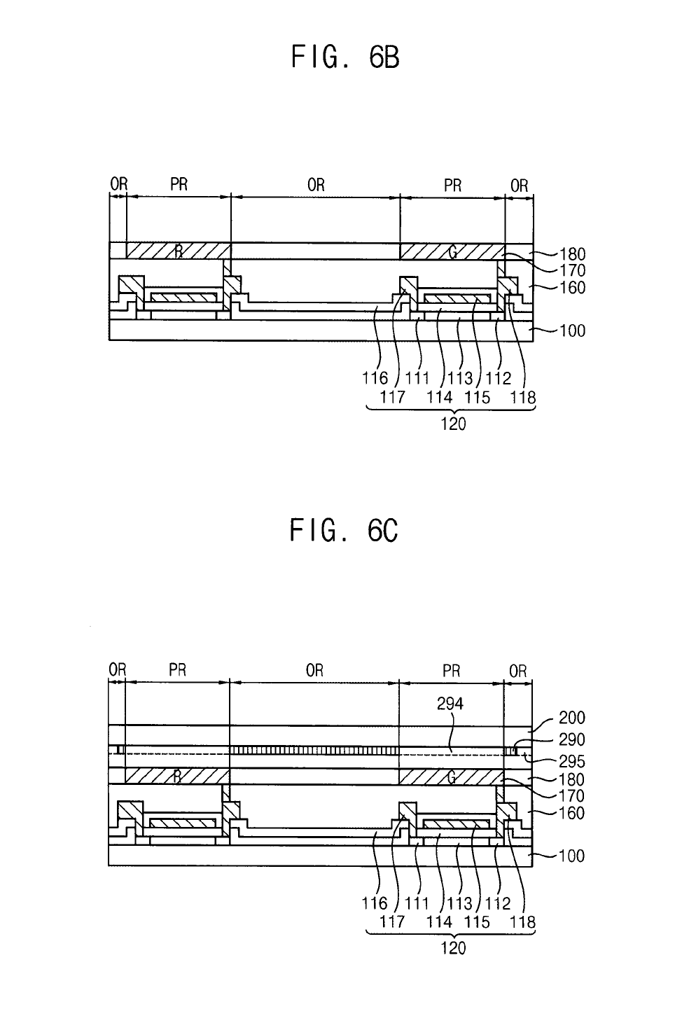

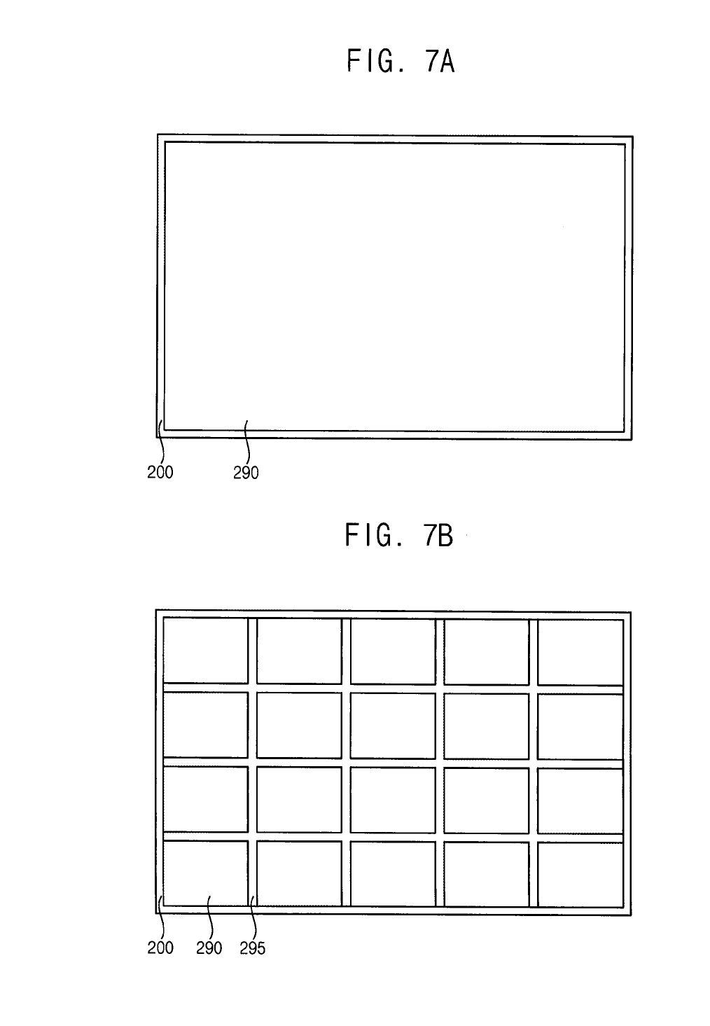

FIG. 4 is a cross sectional view illustrating a mirror type display apparatus according to another exemplary embodiment of the present invention. FIG. 5 is a plan view illustrating a protective substrate and a reflective layer of the mirror type display apparatus of FIG. 4.

Referring to FIG. 4, the mirror type display apparatus includes a base substrate 100, a driving device 120, a display device 170, a protective substrate 200 and a reflective layer 290 disposed on a surface of the protective substrate 200. All elements except for the reflective layer 290 are substantially same as the corresponding elements of the mirror type display apparatus of the FIGS. 1 to 3. Thus, duplicated description will be omitted.

The reflective layer 290 is disposed on a surface of the protective substrate 200. The reflective layer 290 may be disposed on a lower surface of the protective substrate 200 or an upper surface of the protective substrate 200. The reflective layer 290 may have a reflectivity, and may include a metal reflecting the visible light. A specific element of the reflective layer 290 is substantially the same as a corresponding element of the reflective layer 190 of the mirror type display apparatus of the FIGS. 1 to 3. Thus, duplicated descriptions will be omitted. The reflective layer 290 may be disposed as island-shaped pattern, and furrows 295 exposing the surface of the protective substrate 200 may be disposed in the space between the island-shaped reflective layers 290. The island-shaped reflective layer 290 may include at least one opening 294. The furrows 295 may minimize the warpage caused by the mismatch of CTE between the protective substrate 200 and the reflective layer 290. In the exemplary embodiment, the furrows 295 may be disposed as lattice pattern including a horizontal line and a vertical line, as illustrated in FIG. 5. In another exemplary embodiment, the furrows 295 may be disposed as a various patterns without regularity. The furrows 295 may be formed in the non-pixel region OR on the protective substrate 200. In other words, the furrow 295 may be formed in any region except for the pixel region PR in which the display device 170 is disposed.

The opening 294 is disposed on the pixel region PR in which the display device 170 is disposed. For example, when the display device 170 includes an organic light emitting diode, each of the openings 294 may be disposed on the pixel region PR in which each of a red-light emitting diode, a green-light emitting diode and a blue-light emitting diode is disposed. Thus, mirror type display apparatus may have high luminance due to the openings 294.

In another exemplary embodiment, a thin reflective layer thinner than the reflective layer 290 may be disposed in a region in which the display device 170 is disposed. In this embodiment, the reflectivity of the mirror type display apparatus may be improved whereas the luminance is reduced as compared to the exemplary embodiments having openings on the display device 170. Thus, this embodiment may apply to a display requiring high reflectivity than high luminance such as side-view mirror display or rear-view mirror display of a vehicle.

According to exemplary embodiment, the mirror type display includes the island-shaped reflective layer 190 and 290 disposed on the upper surface or the lower surface of the protective substrate 200, and the mirror type display includes furrows 195 and 295 exposing the surface of the protective substrate 200. Thus, the furrows 195 and 295 may minimize the warpage caused by the mismatch of CTE between the reflective layer 190 and 290 and the protective substrate 200. The mirror type display apparatus may further include the opening 294 exposing the pixel region PR or thin reflective layer on the pixel region PR. The opening and the thin reflective layer can minimize a reduction of the luminance caused by the reflective layer 190 and 290.

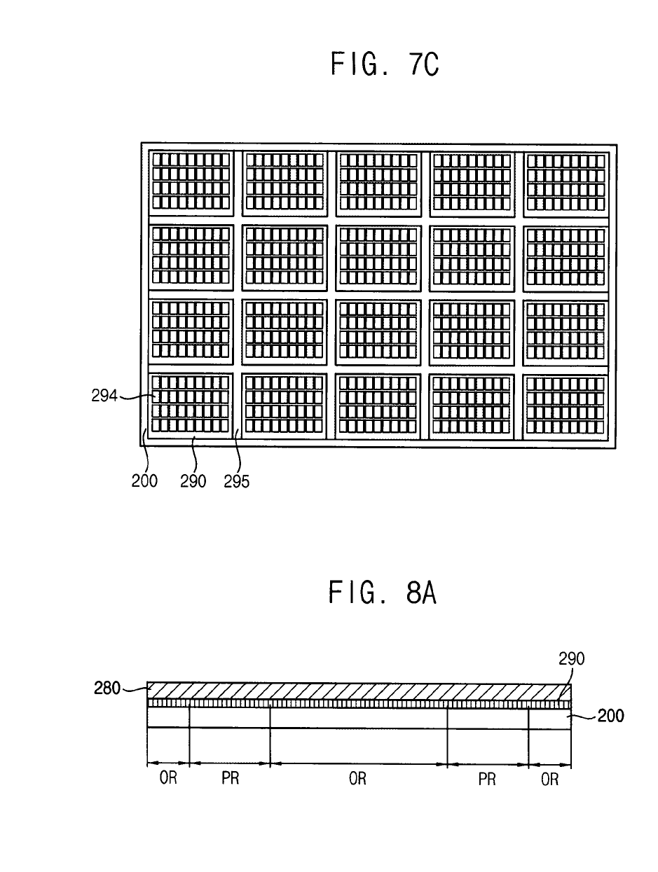

FIGS. 6A to 6C are cross sectional views illustrating a method of manufacturing a mirror type display apparatus according to the exemplary embodiments of the present invention. Referring to FIGS. 6A to 6C, the drawings show the method of manufacturing a mirror type display apparatus of FIG. 4. However, a mirror type display apparatus of FIG. 2 may be formed by well-known modification of the method such as adding or omitting some process to form an element.

Referring to FIG. 6A, a driving device 120 may be formed on a base substrate 100. The driving device 120 may include TFT. The TFT may be formed by following method. For example, the semiconductor layer 111, 112 and 113 may be formed on the base substrate 100. The semiconductor layer 111, 112 and 113 may be a poly silicon, a poly silicon having an impurity, an amorphous silicon, an amorphous silicon having an impurity, an oxide semiconductor, an oxide semiconductor including impurity, etc. The semiconductor layer 111, 112 and 113 may be formed by a chemical vapor deposition (CVD), a plasma-enhanced CVD (PECVD), a high-density-plasma CVD (HDP-CVD), a spin coating process, a thermal oxidation process, a printing process, etc. The semiconductor layer 111, 112 and 113 may be formed by crystallizing an amorphous silicon layer. A gate insulation layer 114 may be formed on the semiconductor layer 111, 112 and 113. The gate insulation layer 114 may be formed by a sputtering process, a CVD, an atomic layer deposition (ALD), a HDP-CVD, a spin coating process, a printing process, etc. A gate electrode 115 is formed on a portion in which the semiconductor layer 111, 112 and 113 is disposed. The gate electrode 115 may be formed by a sputtering process, a CVD, an ALD, a spin coating process, a vacuum deposition, a pulsed-laser-deposition (PLD), a printing process, etc. A first impurity area 111 and a second impurity area 112 may be formed by doping impurity using the gate electrode 115 as a mask. For example, the doping impurity may be conducted by an ion implantation. A depletion region 113 acts as a channel region of the TFT. An insulating interlayer 116 covering the gate electrode 115 may be formed on the gate insulation layer 114. The insulating interlayer 116 may be formed by a sputtering process, a CVD, a PECVD, an ALD, a spin coating process, a vacuum deposition, a PLD, a printing process, etc. Contact holes exposing portions of the first impurity region 111 and the second impurity region 112 may be formed by etching. A source electrode 117 and a drain electrode 118 filling the contact holes may be formed on the insulating interlayer 116. The source electrode 117 and the drain electrode 118 may be formed by a sputtering process, a CVD, a PECVD, an ALD, a spin coating process, a vacuum deposition, a PLD, a printing process, etc. At least one insulation layer 160 may be formed on the source electrode 117 and the drain electrode 118. The insulation layer 160 may be formed by a spin coating process, a printing process, a vacuum deposition, etc.

Referring to FIG. 6B, a display device 170 electrically connected to the driving device 120 may be formed on the insulation layer 160. The display device 170 may include an organic light emitting diode, a liquid crystal device, a display device of PDP, according to a type of the display. For example, when the display device includes an organic light emitting diode, a first electrode electrically connected to the driving device may be formed by forming a conductive layer using a sputtering process, a CVD, a PECVD, an ALD, a vacuum deposition, a PLD, etc, and a patterning the conductive layer to form the first electrode using a photolithography process, etc. After that, a pixel definition layer 180 including an opening may be formed on the first electrode. The pixel definition layer 180 may be formed by a spin coating process, a printing process, a vacuum deposition, etc. An organic layer may be formed in the opening of the pixel definition layer 180. The organic layer may be formed by a deposition, a mask deposition, a photoresist process, a printing process, an ink jet process, etc. A second electrode covering the organic layer and the pixel definition layer 180 may be formed by a sputtering process, a printing process, a spray process, a CVD, an ALD, a vacuum deposition, a PLD, etc.

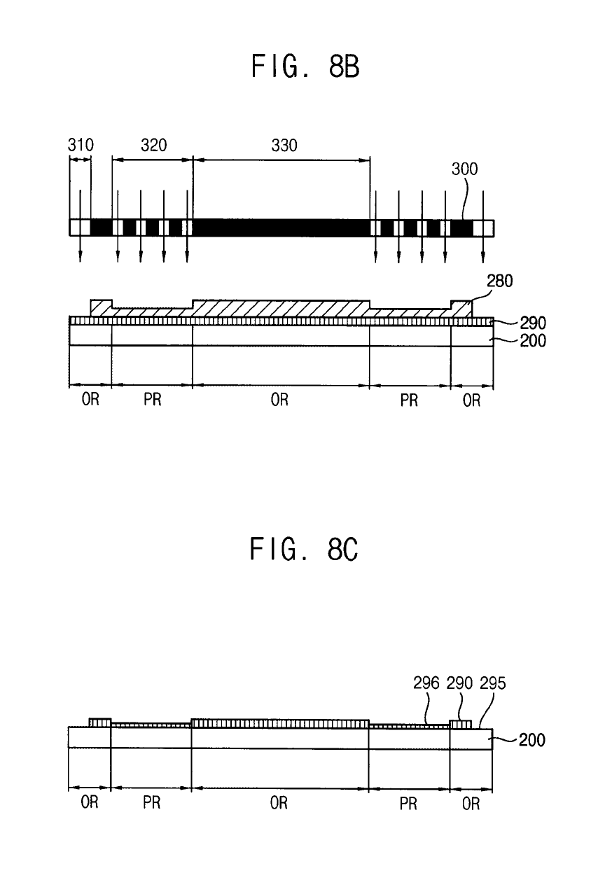

Referring to FIG. 6C, in the exemplary embodiment, a reflective layer 290 may be formed on a lower surface of the protective substrate 200 covering the display device 170. In another exemplary embodiment, the reflective layer 290 may be formed on an upper surface of the protective substrate 200. A method of forming the reflective layer 290 will be described in detail with reference to FIGS. 7A to 7C. In still another exemplary embodiment, an additional film may be formed on the same side on which the reflective layer 290 is formed, or the additional film may be formed on another side on which the reflective layer 290 is not formed. For example, the reflective layer 290 is formed on the lower surface of the protective substrate 200, and the additional film including titanium dioxide is formed on the upper surface of the protective substrate 200, in order to prevent a wavering of the image. The additional film including titanium dioxide may be formed by a deposition, a mask deposition, a photoresist process, a printing process, an ink jet process, etc, or the additional film may be formed by bonding the film to the protective substrate 200 using a transparent adhesive tape such as polyvinyl alcohol-based adhesive. However, the method of forming the reflective layer 290 is not limited by the exemplary embodiments above.

After that, encapsulation of the base substrate 100 using the protective substrate 200 including the reflective layer 290 is performed. The encapsulation is achieved by bonding the base substrate 100 and the protective substrate 200 after applying the sealing material on the lower surface of the protective substrate 200. The sealing material may include an inorganic material such as a frit or an organic material such as an epoxy resin which may be used alone or in combination. The multilayer sealing materials may be used. The bonding is achieved by hardening process, and the hardening process may be conducted by radiating a laser or an ultraviolet ray to the sealing material, or heating the sealing material in a high temperature.

FIGS. 7A to 7C are plan views illustrating a method of forming a reflective layer of a mirror type display apparatus according to exemplary embodiments of the present invention. The method of forming the reflective layer 290 is described hereinafter.

Referring to FIG. 7A, the method of forming the reflective layer 290 may include following procedure. First, forming the reflective layer 290 on the upper surface or the lower surface of the protective substrate 200, using a metal. The reflective layer 290 may be formed directly on the protective substrate 200 without intervening adhesive layer. The reflective layer 290 may be formed by a deposition, a mask deposition, a photoresist process, a printing process, an ink jet process, etc. The deposition may include a sputtering process, a CVD, a PLD, a vacuum deposition, an ALD, etc. However the deposition is not limited to the examples listed above.

Referring to FIG. 7B, furrows 295 exposing the protective substrate 200 may be formed by a patterning the deposited reflective layer 290. For example, the furrows 295 may be formed by a photolithography process.

Referring to FIG. 7C, an opening 294 exposing the protective substrate 200 may be formed by a patterning the deposited reflective layer 290 corresponding the pixel region PR in which the display device is disposed. For example, the opening 294 may be formed by a photolithography process.

In another example of method of forming the reflective layer 290, an order of forming the opening 294 and forming the furrows 295 may be changed.

In still another example of method of forming the reflective layer 290, forming the opening 294 may be conducted at the same time as forming the furrows 295. For example, the opening 294 and the furrows 295 may be formed by aligning a mask patterned as FIG. 7C on the reflective layer 290, and patterning the reflective layer 290 by a photolithography process.

In still another example of method of forming the reflective layer 290, a thin reflective layer may be formed in a region corresponding to the display device. The thin reflective layer may be formed to have thin thickness by removing a portion of reflective layer 290. For example, the thin reflective layer 290 may be formed by etching the portion of the reflective layer 290 by a photolithography process.

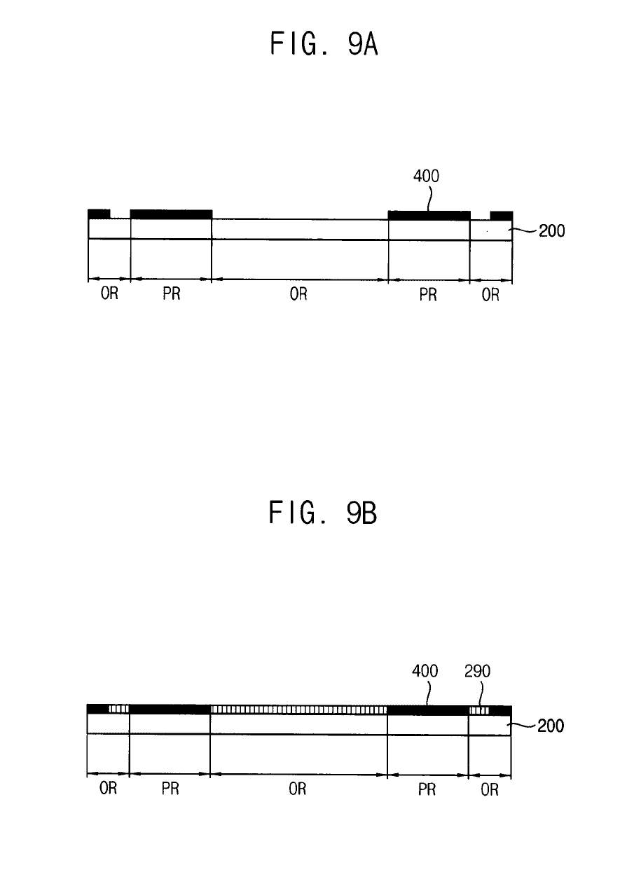

FIGS. 8A to 8C are cross sectional views illustrating a method of forming a reflective layer of a mirror type display apparatus according to exemplary embodiments of the present invention.

Referring to FIGS. 8A to 8C, in the method of forming the reflective layer 290, the thin reflective layer 296 and the furrows 295 may be formed at once using a half-tone mask 300.

Referring to FIG. 8A, the reflective layer 290 may be formed on the lower surface of the protective substrate 200. The reflective layer 290 may be formed by a deposition, a mask deposition, a photoresist process, a printing process, an ink jet process, etc. After forming the reflective layer 290, a region photoresist 280 may be formed on the reflective layer 290.

Referring to FIG. 8B, after forming the region photoresist 280 on the reflective layer 290, the half-tone mask 300 is aligned with the protective substrate 200. The half-tone mask 300 includes transmitting region 310, half-tone region 320 and shading region 330. The transmitting region 310 completely exposes the region, and the shading region 330 completely blocks the region, but the half-tone region 320 half-exposes the region. For example, the transmitting region 310 of half-tone mask 300 may be aligned to the region in which the furrows 295 are formed, and the shading region 330 may be aligned to the region in which the reflective layer 290 is formed, and the half-tone region 320 may be aligned to the region in which the thin reflective layer 296 is formed. However, when the negative photoresist is used, the alignment of the half-tone mask 300 may be changed. The photoresist 280 is developed to have a first region corresponding to the furrows in which no photoresist 280 is remained, a second region corresponding to the pixel region in which the photoresist 280 is thinned, and the third region in which the photoresist 280 is remain thick as it is applied.

Referring to FIG. 8C, the furrows 295 may be formed by etching the reflective layer 290 using a thinned photoresist pattern and the remained photoresist patterns as a mask. Then, the pixel region PR is exposed by removing the thinned photoresist. The removing the photoresist in the pixel region PR is performed by an ashing process or an etching process. After removing the thinned photoresist in the pixel region PR, the reflective layer on the pixel region PR is partially removed. The removal of the reflective layer 290 may be conducted by various methods such as a wet etching, a dry etching, a plasma etching, etc. The remained photoresist is removed and the protective substrate 200 as shown in FIG. 8C is obtained.

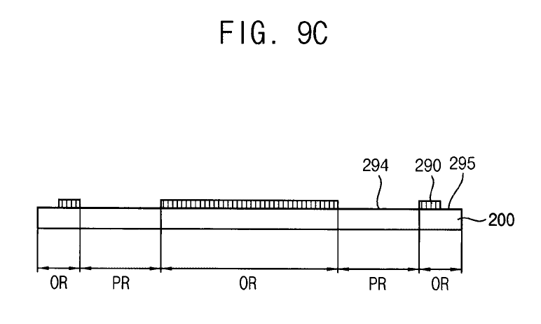

FIGS. 9A to 9C are cross sectional views illustrating a method of forming a reflective layer of a mirror type display apparatus according to exemplary embodiment of the present invention.

Referring to FIGS. 9A to 9C, the island-shaped reflective layer 290, the furrows 295 disposed in the space between the island-shaped reflective layers 290 and the opening 294 disposed in the pixel region PR may be formed simultaneously by a mask deposition.

Referring to FIG. 9A, a mask 400 having opening corresponding to the furrows 295 and the opening 294 is aligned with the protective substrate 200 in order to block a region in which the opening 294 and the furrows 295 are formed.

Referring to FIG. 9B, a raw material to form the protective layer 290 is deposited on the protective substrate 200 by a vacuum deposition, a sputtering process, etc.

Referring to FIG. 9C, the island-shaped reflective layer 290, the furrows 295 and the opening 294 may be formed by removing the mask 400. In this exemplary, a cost of manufacturing the mirror type display can be reduced because the island-shaped reflective layer 290, the furrows 295 and the opening 294 are formed using one mask and one process without employing photolithography process.

According to the method of manufacturing the mirror type display apparatus, the warpage is minimized in the protective substrate 200. In addition, luminance and reflectivity of the mirror type display apparatus may be improved.

Although exemplary embodiments of the present inventive concept is applied to the organic light emitting display apparatus, the present inventive concept may also be applied to a liquid crystal display apparatus, a plasma display apparatus.

The present inventive concept may be applied to an electronic device having a mirror type display apparatus. For example, the present inventive concept may be applied to a top emission type display apparatus, bottom emission type display apparatus and duplex emission type display apparatus. The present inventive concept may be applied to a mirror in a dressing room, a bath room and a rest-room, and may be applied to a rear-view mirror or a side-view mirror of a vehicle as a GPS navigator monitor, and may be applied to a decoration panel or an advertising panel in a store. In addition, the present inventive concept may be applied to a mirror in a beauty-shop in order to predict a changed looks of a person who undergoes a cosmetic procedure.

The foregoing is illustrative of exemplary embodiments and is not to be construed as limiting the scope of the inventive concept. Although a few exemplary embodiments have been described, those skilled in the art will readily appreciate that many modifications are possible in the exemplary embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various exemplary embodiments and is not to be construed as limited to the specific exemplary embodiments disclosed, and that modifications to the disclosed exemplary embodiments, as well as other exemplary embodiments, are intended to be included within the scope of the appended claims.

What is claimed is:

1. A mirror type display apparatus comprising:
a base substrate having a pixel region and a non-pixel region surrounding the pixel region;
a driving device disposed on the base substrate;
a display device disposed in the pixel region of the base substrate, the display device being electrically connected to the driving device;
a protective substrate opposing the base substrate, the protective substrate protecting the driving device and the display device; and
an island-shaped reflective layer disposed on a surface of the protective substrate, the island-shaped reflective layer including the island-shaped reflective layers separated by furrows formed on the protective substrate.

2. The display apparatus of claim 1, wherein the island-shaped reflective layer comprises a metal.

3. The display apparatus of claim 2, wherein the island-shaped reflective layer further comprises an opening exposing the pixel region.

4. The display apparatus of claim 3, wherein the island-shaped reflective layer comprises a thick reflective layer and a thin reflective layer thinner than the thick reflective layer, and the thin reflective layer is disposed on the pixel region.

5. A method of manufacturing a mirror type display apparatus, the method comprising:
forming a driving device on a base substrate having a pixel region and a non-pixel region surrounding the pixel region;
forming a display device on the base substrate, the display device being electrically connected to the driving device;
forming a reflective layer on a surface of a protective substrate, the reflective layer being island-shaped reflective layers separated by furrows formed on the protective substrate; and
bonding the protective substrate to the base substrate to encapsulate the driving device and the display device.

6. The method of claim 5, wherein the forming the reflective layer further comprises forming an opening on the pixel region.

7. The method of claim 6, wherein the forming an opening and forming the reflective layer is performed at the same time.

8. The method of claim 7, wherein the forming an opening and the forming the reflective layer is formed by a mask deposition.

9. The method of claim 5, wherein the forming the reflective layer further comprises partially removing the reflective layer on the pixel region.

10. The method of claim 9, wherein the forming the reflective layer comprises;
forming region photoresist on the reflective layer;
exposing the photoresist using a half-tone mask having a transmitting region, a shading region and a half-tone region corresponding to the pixel region;
developing the photoresist;
etching the reflective layer to form the furrows;
removing the photoresist on the pixel region; and
partially removing the reflective layer on the pixel region.
